(19) United States
(12) Patent Application Publication
(10) Pub. No.: US 2010/0031962 A1
(43) Pub. Date: Feb. 11, 2010

(54) Detachable Disposable Mask and a Disposable Mask Body Thereof

(76) Inventor: Chun-Liang Chiu, Taiwan (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/225,424

(22) PCT Filed: Feb. 7, 2007
(86) PCT No.: PCT/CN2007/000425

§ 371 Date: Sep. 22, 2008

(30) Foreign Application Priority Data
Mar. 24, 2006 (CN) 200610066167.3

(51) Int. Cl. A62B 23/02

(52) U.S. Cl. 128/206.19

(57) ABSTRACT

A detachable disposable mask and a disposable mask body thereof is disclosed. The detachable disposable mask includes a disposable mask body and two straps. The disposable mask body has a thermoplastic filter sheet that contains polyolefin material. Each strap has two assembling members respectively located on two ends thereof. The assembling members are detachably assembled on the disposable mask body. After a period of use, the filtering effect of the disposable mask body is reduced, so the disposable mask body must be abandoned. However, since the assembling members of the straps are detachably assembled on the disposable mask body, the straps needn't be abandoned following the disposable mask body. Accordingly, the detachable disposable mask can avoid waste of straps, reduce users' purchase cost and improve the effect of environmental protection. The present invention claims the benefit of Chinese Patent Application No. 200610066167.3, filed Mar. 24, 2006.

### BACKGROUND OF THE INVENTION

1. Field of the Invention

The present invention relates to a mask, and in particular to a detachable disposable mask and a disposable mask body thereof; and the present invention claims the benefit of Chinese Patent Application No. 200610066167.3, filed Mar. 24, 2006.

2. Description of Related Art

Masks are used for covering users' mouths and noses to prevent pollutions from external environment enters users' bodies via their mouths and noses, or avoid that users' internal fluid to spread to external environment via users' mouths and noses. With the elevation of health and sanitation awareness, masks are used widely. For example, medical personnel and patients in medical institutions and motorcycle riders all have a need to use masks. So masks are in a great demand.

A conventional mask includes a mask body and two straps. The mask body is made of a washable cotton fabric. Two ends of each strap are permanently sewn on two ends the mask body respectively by machine. When a user wears the conventional mask, the mask body covers the user's mouth and nose and the straps are adjusted to a proper length to be hanged on the user's ears.

When the conventional mask has been used for a period of time, the filtering effect of the mask body is reduced, so the mask body must be abandoned, but the straps can still be used. However, since the straps are permanently sewn on the mask body by machine, they must be abandoned along with the mask body. As a result, the straps are wasted and users' purchase cost is increased. Also, the abandoned straps result in the increase of garbage waste amount and so environmental impact is negatively affected.

Additionally, when the user wears a newly purchased conventional mask to replace the used mask, the straps of the new mask must be adjusted again, which is inconvenient for use.

Another conventional mask, for example, a planar mask structure disclosed by Taiwan Patent Publication No. 379567, includes a mask body and two straps. The mask body can be abandoned. The straps are connected with the mask body via ultrasonic rolling press or sewing. In other words, two ends of each strap are respectively permanently combined with two ends of one corresponding side of the mask body.

The straps of the above mask are permanently combined with the mask body, so the mask also results in waste of the straps and increases users' purchase cost when abandoned. Furthermore, the mask is inconvenient for use due to the need for readjustment of straps and also has a negative impact on the environment.

Hence, the inventors of the present invention believe that the shortcomings described above are able to be improved and finally suggest the present invention which is of a reasonable design and is an effective improvement based on extensive research and evaluation.

### SUMMARY OF THE INVENTION

An object of the present invention is to provide a detachable disposable mask and a disposable mask body thereof which can avoid waste of straps, reduce users' purchase cost, and improve the effect of environmental impact. The detachable disposable mask and the disposable mask body thereof is convenient for use since there is no need to adjust the straps every time the disposable mask body is replaced.

To achieve the above-mentioned object, a detachable disposable mask in accordance with the present invention is provided. The detachable disposable mask includes a disposable mask body and two straps. The disposable mask body has a thermo-plastic filter sheet that contains polyolefin material. Each strap has two assembling members respectively located on two ends thereof, and the assembling members are detachably assembled on the disposable mask body.

To achieve the above-mentioned object, a disposable mask body of a detachable disposable mask in accordance with the present invention is provided. The disposable mask body of the detachable disposable mask includes a thermo-plastic filter sheet which contains polyolefin material.

The thermo-plastic filter sheet which contains polyolefin material has a good filtering effect.

After the detachable disposable mask has been used for a period of time, the filtering effect of the disposable mask body is reduced, so the disposable mask body must be abandoned, but the straps can be still used. Since the assembling members of the straps are detachably assembled on the disposable mask body, the straps need not be abandoned along with the disposable mask body. Users only need to prepare a new disposable mask body, and then detachably assemble the assembling members of the straps onto the new disposable mask body again. Accordingly, the detachable disposable mask can avoid waste of straps, reduce users' purchase cost, and avoid increasing strap rubbish, which has a positive impact on the environment.

Furthermore, since the lengths of the straps are retained, users need not readjust the straps, so the detachable disposable mask is convenient for use.

Additionally, manufacturers can provide various forms of straps to meet users' fondness and requirements.

To further understand the technologies, methods, and efficacy of the present invention, please refer to the following detailed description and drawings related to the present invention, and it is believed that the objects, characteristics, and features of the present invention can be further understood. However, the drawings are only to be used as references and illustrations, and not meant to limit the present invention.

### BRIEF DESCRIPTION OF THE DRAWINGS

FIG. 1 is a partially exploded perspective view of a first embodiment of a detachable disposable mask of the present invention;

FIG. 2 is a partially cross-sectional view of the first embodiment of the detachable disposable mask of the present invention;

FIG. 3 is a partially exploded perspective view of the first embodiment of the detachable disposable mask of the present invention, wherein an assembling portion of a disposable mask body of the first embodiment further includes a thermo-plastic enhancing board;

FIG. 4 is a partially exploded perspective view of a second embodiment of the detachable disposable mask of the present invention;

FIG. 5 is a partially exploded perspective view of a third embodiment of the detachable disposable mask of the present invention;

FIG. 6 is a partially exploded perspective view of a fourth embodiment of the detachable disposable mask of the present invention;

FIG. 7 is a partially exploded perspective view of a fifth embodiment of the detachable disposable mask of the present invention;

FIG. 8 is a partially exploded perspective view of a sixth embodiment of the detachable disposable mask of the present invention;

FIG. 9 is a partially exploded perspective view of a seventh embodiment of the detachable disposable mask of the present invention;

FIG. 10 is a partially exploded perspective view of an eighth embodiment of the detachable disposable mask of the present invention;

FIG. 11 is a partially exploded perspective view of a ninth embodiment of the detachable disposable mask of the present invention; and

FIG. 12 is a partially exploded perspective view of a tenth embodiment of the detachable disposable mask of the present invention.

### DETAILED DESCRIPTION OF PREFERRED EMBODIMENTS

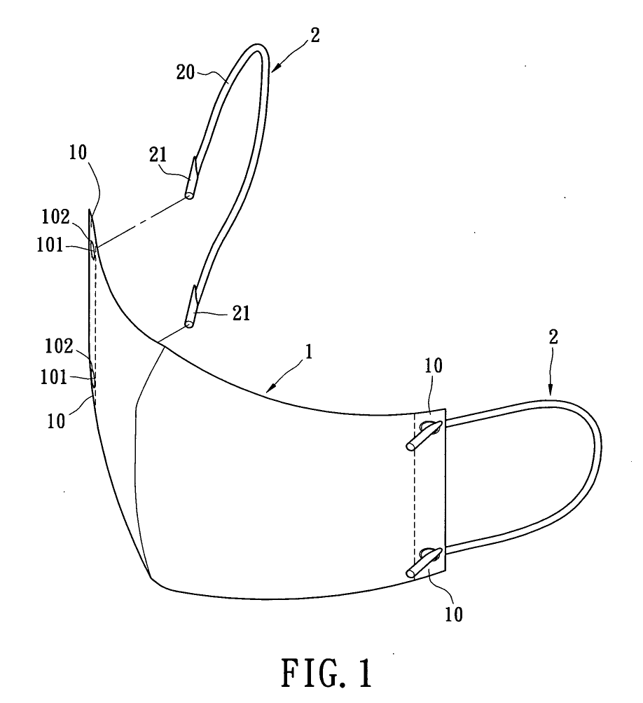

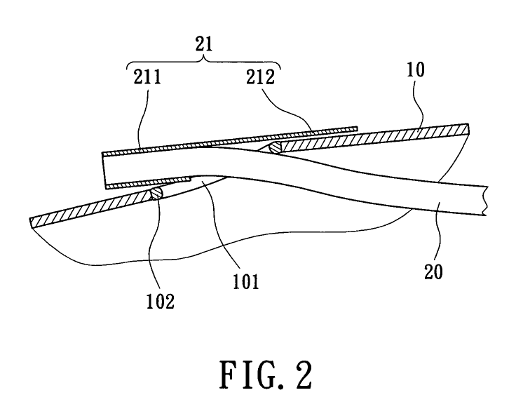

The present invention provides a detachable disposable mask and a disposable mask body thereof. Please refer to FIG. 1 and FIG. 2 illustrating a first embodiment of the present invention. The detachable disposable mask includes a disposable mask body 1 and two straps 2.

The disposable mask body 1 has a thermo-plastic filter sheet which contains polyolefin material for a good filtering effect. Also, the disposable mask body 1 further has a thermo-plastic non-woven layer for improving toughness. The thermo-plastic non-woven layer is combined with the thermo-plastic filter sheet by hot melt. The thermo-plastic non-woven layer is a thermo-plastic non-woven layer of filament fibers which contains polyolefin material or a thermo-plastic non-woven layer of staple fibers which contains polyolefin material. Additionally, the disposable mask body 1 may be flat-shaped or cup-shaped etc.

The disposable mask body 1 has four assembling portions 10 respectively located on two ends of two opposite sides thereof, in other words, respectively located at four corners of the disposable mask body 1. Each assembling portion 10 has a perforation 101. The rim of the perforation 101 of each assembling portion 10 is further hot melted to form an enhancing ring 102, thereby increasing the strength of each assembling portion 10. In the embodiment, each enhancing ring 102 is circular. Alternatively, the enhancing ring 102 may be of other shapes.

Each strap 2 has a strap body 20 and two assembling members 21. Each strap body 20 may be an elastic strap which is made of any material with elasticity. For example, each strap body 20 may have an elastic layer of thermo-plastic polyurethane (TPU). Or, for example, each strap body 20 may have an elastic layer of thermo-plastic polyurethane and a thermo-plastic non-woven layer. The thermo-plastic non-woven layer may be a non-woven layer of filament fibers. Or, for example, each strap body 20 may have a thermo-plastic elastic layer which contains polyolefin material or copolymer of polyolefin material. Or, for example, each strap body 20 may have a thermo-plastic elastic layer which contains polyolefin material or copolymer of polyolefin material, and a thermo-plastic non-woven layer of filament fibers.

The assembling members 21 of each strap 2 are respectively located on two ends of each strap 2. The assembling members 21 are detachably assembled onto the disposable mask body 1. In the embodiment, each assembling member 21 is a hook wedge. Each assembling member 21 (hook wedge) has a fixing portion 211 and a hook joint portion 212. The fixing portions 211 of the assembling members 21 (hook wedges) of each strap 2 are respectively fixed on two ends of the strap body 20 of each strap 2. The hook joint portions 212 of the assembling members 21 (hook wedges) respectively extend along the corresponding strap bodies 20.

During assembly, at first, the assembling members 21 (hook wedges) of each strap 2 respectively pass through the perforations 101 on the corresponding side of the disposable mask body 1, so that the straps 2 are respectively located on the two opposite sides of the disposable mask body 1 (e.g. right and left here being opposite, with one strap located at the right side, and another strap located at the left side). Then, each strap 2 is pulled rearwards so that the hook joint portions 212 of the assembling members 21 (hook wedges) respectively hook on to the rims of the perforations 101 of the assembling portions 10, thereby the hook joint portions 212 of the assembling members 21 (hook wedges) detachably engage with the perforations 101 of the assembling portions 10, respectively. So the assembling members 21 (hook wedges) of each strap 2 are detachably assembled onto the assembling portions 10 located on one corresponding side of the disposable mask body 1 to form an ear-hook type mask (e.g. one corresponding side is the right side, and the other corresponding side is the left side).

When a user wears the detachable disposable mask, the disposable mask body 1 is used for covering the user's mouth and nose, and the straps 2 are respectively adjusted to proper length to be hanged on the user's ears. Each strap 2 is pulled rearwards so that the assembling members 21 (hook wedges) securely detachably engage with the perforations 101 of the assembling portions 10, respectively, thereby the disposable mask body 1 is close to the user's mouth and nose properly.

After a period of use, the filtering effect of the disposable mask body 1 is reduced, so the disposable mask body 1 must be abandoned, but the straps 2 can be still used. During detachment, the two ends of each strap 2 are pulled forwards so that the hook joint portions 212 of the assembling members 21 (hook wedges) are detached from the rims of the perforations 101 of the assembling portions 10, respectively. So the assembling members 21 (hook wedges) can be disengaged from the perforations 101, thereby the straps 2 are detached from the disposable mask body 1. Since the assembling members 21 of the straps 2 are detachably assembled on the disposable mask body 1, the straps 2 need not be abandoned along with the disposable mask body 1. Users only need to prepare a new disposable mask body 1, and then detachably assemble the assembling members 21 of the straps 2 onto the new disposable mask body 1. Accordingly, the detachable disposable mask can avoid waste of straps, reduce users' purchase cost, and avoid increasing strap rubbish, which is positive the environment.

Furthermore, since the length of the straps 2 are retained, users needn't readjust the straps 2, so the detachable disposable mask is convenient for use.

Additionally, manufacturers can provide various forms of straps to meet users' fondness and requirements.

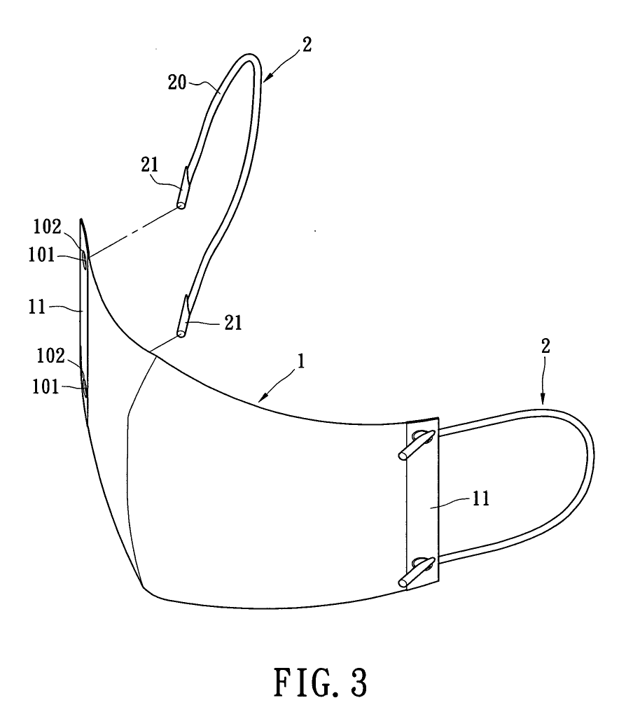

FIG. 3 illustrates that each assembling portion 10 of the first embodiment of the present invention further has a thermoplastic enhancing board 11 for increasing the strength of the assembling portions 10.

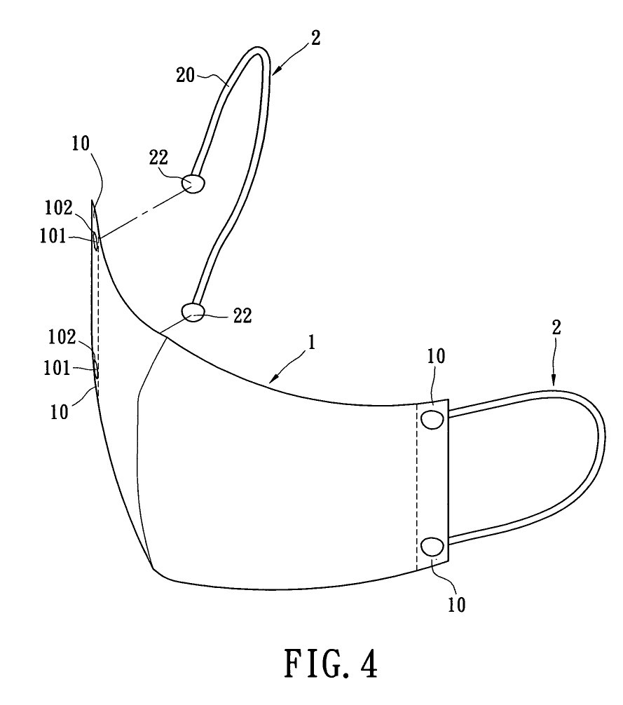

Please refer to FIG. 4 illustrating a second embodiment of the present invention. The difference between the second embodiment and the first embodiment is assembling members 22 of the straps 2. In the second embodiment, each assembling member 22 is an elastic protruding block. The assembling members 22 (elastic protruding blocks) of each strap 2 are respectively formed on the two ends of each strap body 20. The normal cross section area of each assembling member 22 (elastic protruding block) is greater than the diameter of the perforation 101 of the corresponding assembling portion 10. During assembly, the assembling members 22 (elastic protruding blocks) of each strap 2 are compressed to reduce their cross section area, thereby passing through the perforations 101 on the corresponding side of the disposable mask body 1, so that the straps 2 are located on the two sides of the disposable mask body 1, respectively (e.g. one side being the right side and the other side being the left side). Then the assembling members 22 of each strap 2 returns to normal (e.g. decompress). Accordingly, the assembling members 22 (elastic protruding blocks) respectively detachably engage with the perforations 101 of the assembling portions 10. During detachment, the assembling members 22 (elastic protruding blocks) of each strap 2 are compressed again to reduce their cross section area, thereby passing through the perforations 101, so that the straps 2 are detached from the disposable mask body 1, respectively.

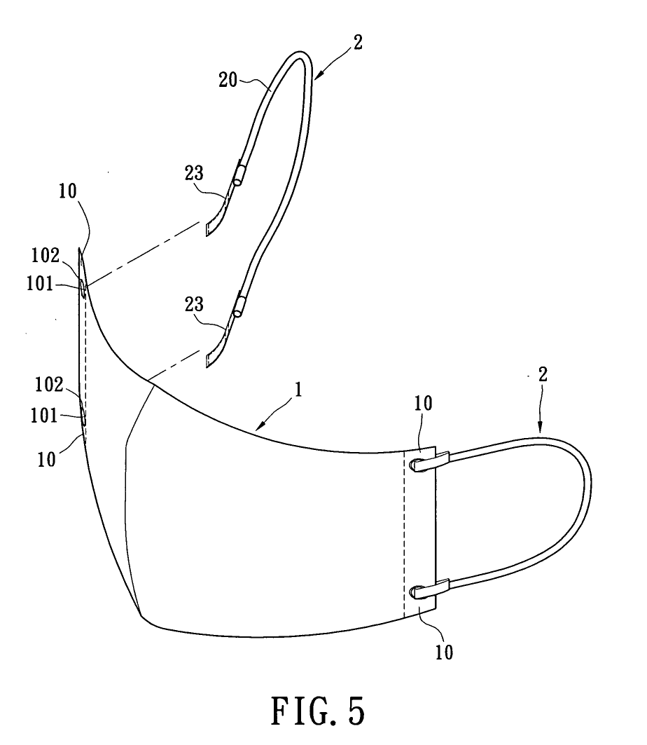

Please refer to FIG. 5 illustrating a third embodiment of the present invention. The difference between the third embodiment and the first embodiment is assembling members 23 of the straps 2. In the third embodiment, each assembling member 23 is a nylon velcro. The assembling members 23 (velcro) of each strap 2 are respectively connected to the two ends of the strap body 20 of each strap 2. The assembling members 23 (velcro) respectively interlock the perforations 101 of the assembling portions 10 and are respectively assembled on the perforations 101 of the assembling portions 10.

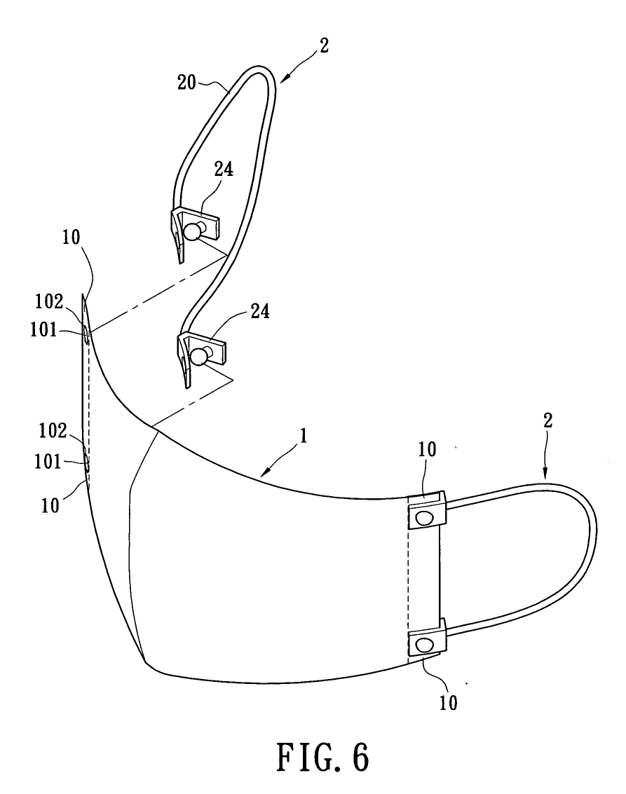

Please refer to FIG. 6 illustrating a fourth embodiment of the present invention. The difference between the fourth embodiment and the first embodiment is assembling members 24 of the straps 2. In the fourth embodiment, each assembling member 24 is a male and female fastener. The assembling members 24 (male and female fasteners) of each strap 2 are formed on the two ends of the strap body 20 of each strap 2. The assembling members 24 (male and female fasteners) respectively interlock the perforations 101 of the assembling portions 10 and are respectively assembled on the perforations 101 of the assembling portions 10.

From the first, the second, the third, and the fourth embodiments, the assembling members of each strap 2 may have various forms, which aren't limited to the above embodiments.

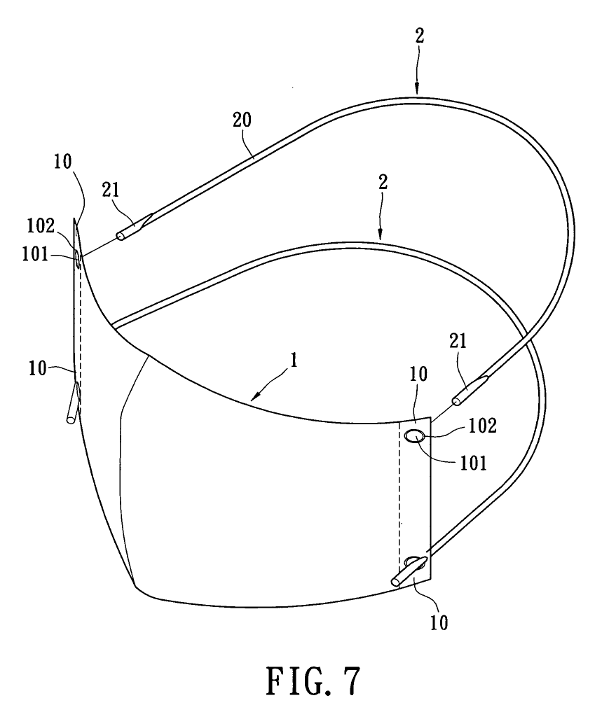

Please refer to FIG. 7 illustrating a fifth embodiment of the present invention. The difference between the fifth embodiment and the first embodiment is the positions of the straps 2. In the fifth embodiment, the assembling members 21 (hook wedges) of each strap 2 are respectively detachably assembled on two corresponding assembling portions 10 of the two opposite sides of the disposable mask body 1 to form a head-wearing type mask; wherein top and right here being opposite, with one strap located on the top side, and another strap located at the bottom side.

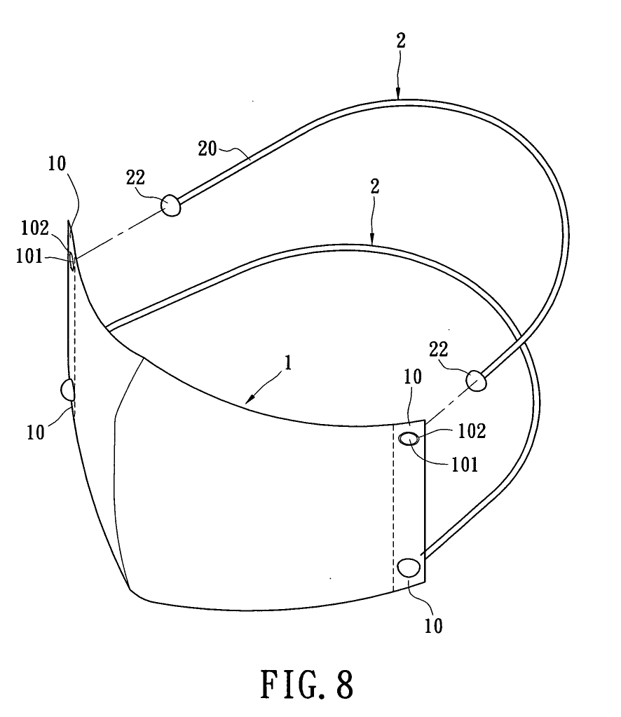

Please refer to FIG. 8 illustrating a sixth embodiment of the present invention. The difference between the sixth embodiment and the second embodiment is the positions of the straps 2. The positions of the straps 2 of the sixth embodiment are the same like those of the straps 2 of the fifth embodiment.

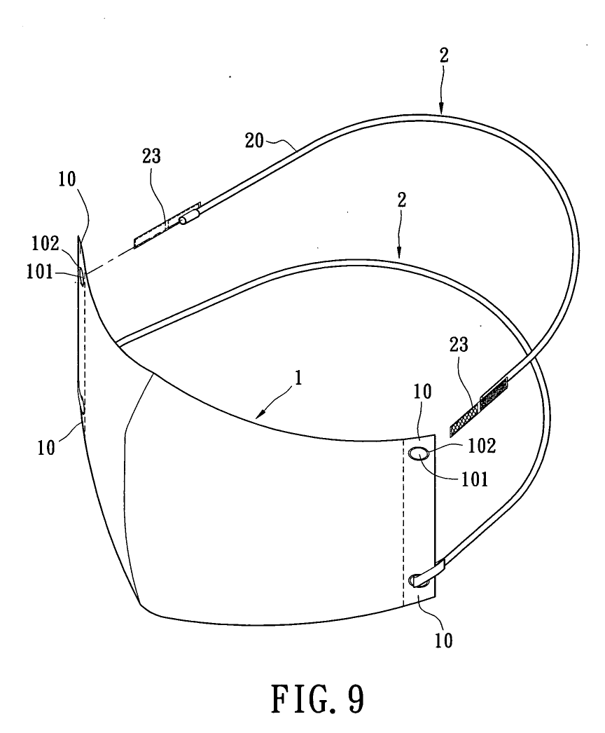

Please refer to FIG. 9 illustrating a seventh embodiment of the present invention. The difference between the seventh embodiment and the third embodiment is the positions of the straps 2. The positions of the straps 2 of the seventh embodiment are the same as that of the straps 2 of the fifth embodiment.

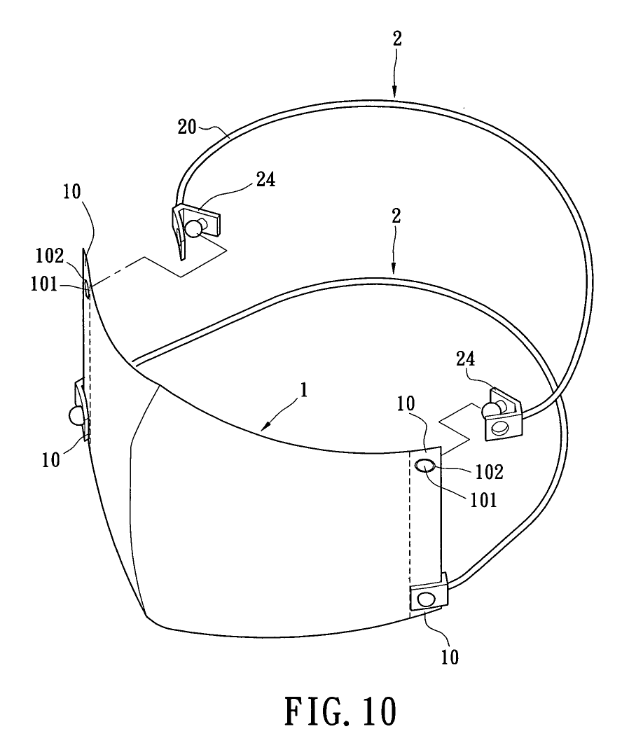

Please refer to FIG. 10 illustrating an eighth embodiment of the present invention. The difference between the eighth embodiment and the fourth embodiment is the positions of the straps 2. The positions of the straps 2 of the eighth embodiment are the same as the straps 2 of the fifth embodiment.

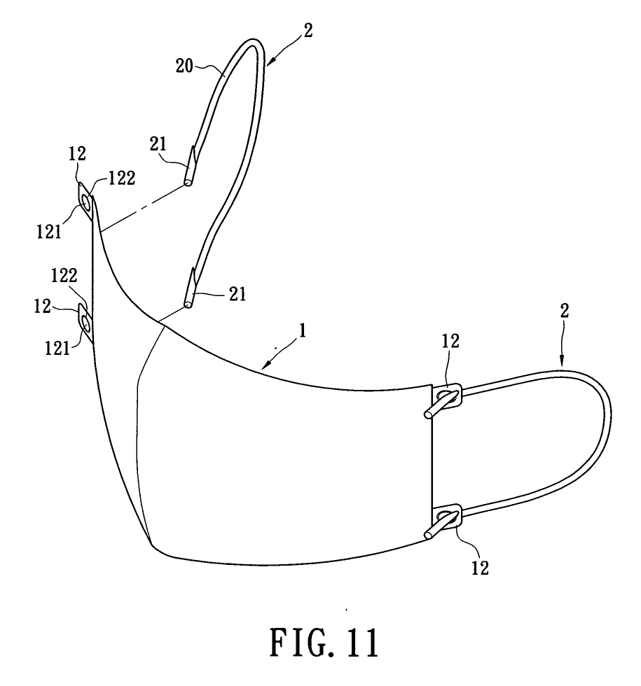

Please refer to FIG. 11 illustrating a ninth embodiment of the present invention. The difference between the ninth embodiment and the first embodiment is that:

Each of the two opposite sides of the disposable mask body 1 respectively extends outwards to form two spaced ear portions 12. Each ear portion 12 has a perforation 121, and the rim of the perforation 121 melts to form an enhancing ring 122.

During assembly, the assembling members 21 (hook wedges) respectively hook on to the rims of the perforations 101 of the ear portions 12, thereby the assembling members 21 (hook wedges) of each strap 2 are respectively detachably assembled onto the ear portions 12 located on the corresponding side (e.g. one of the correspond side being the right side, and the other being the left side) of the disposable mask body 1 to form an ear-hook type mask.

Also, like the fifth, the sixth, the seventh, and the eighth embodiments, the engaging positions of the straps 2 and the ear portions 12 can be changed so as to change the mask from an ear-hook type mask to a head-wearing type mask (not shown).

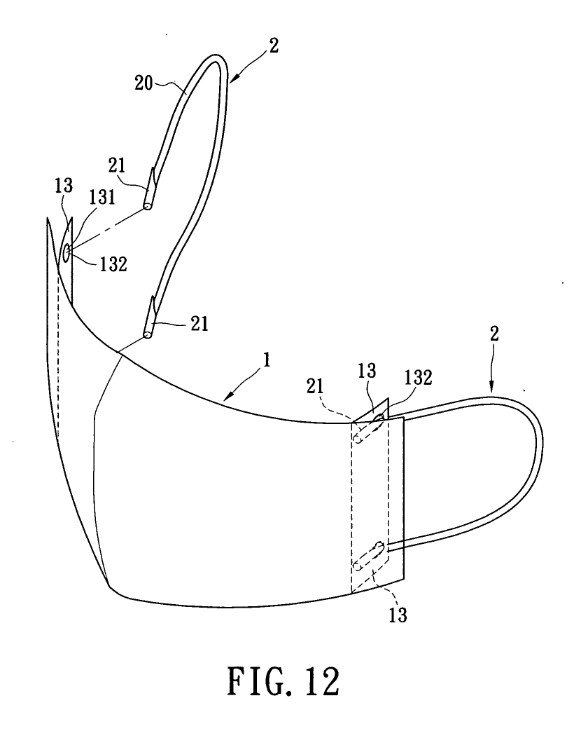

Please refer to FIG. 12 illustrating a tenth embodiment of the present invention. The difference between the tenth embodiment and the first embodiment is that:

Four extending portions 13 extend from the disposable mask body 1, in the embodiment, the extending portions 13 are formed by extending the inner side of the disposable mask body 1 and located on the ends of the disposable mask body 1 close to the two opposite sides of the disposable mask body 1. Each extending portion 13 has a perforation 131, and the rim of perforation 131 melts to form an enhancing ring 132.

During assembly, the assembling members 21 (hook wedges) respectively hook on to the rims of the perforations 131 of the extending portions 13, so that the assembling members 21 (hook wedges) of each strap 2 are respectively detachably assembled onto the extending portions 13 located on the corresponding side (e.g. one corresponding side being the right side and the other being the left side) of the disposable mask body 1. So the assembling members 21 are hidden in the disposable mask body 1, thereby the disposable mask body 1 is aesthetically pleasing.

The extending portions 13 may be formed on the outer side of the disposable mask body 1; or, not only on the inner side of the disposable mask body 1, but also on the outer side of the disposable mask body 1, to increase connection strength of the straps 2. Also, like the fifth, the sixth, the seventh, and the eighth embodiments, the engaging positions of the straps 2 and the extending portions 12 can be changed so as to change the mask from an ear-hook type mask to a head-wearing type mask (not shown).

Consequently, the detachable disposable mask and the disposable mask body thereof of the present invention has the advantages as follows:

1. The thermo-plastic filter sheet which contains polyolefin material has a good filtering effect.

2. After a period of use, the filtering effect of the disposable mask body is reduced, so the disposable mask body must be abandoned, but the straps can be still used. Since the assembling members of the straps are detachably assembled on the disposable mask body, the straps need not be abandoned along with the disposable mask body. Users only need to prepare a new disposable mask body, and then detachably assemble the assembling members of the straps onto the new disposable mask body again. Accordingly, the detachable disposable mask can avoid waste of straps, reduce users' purchase cost, and avoid increasing strap rubbish, which is positive for the environment.

3. Since the sizes and lengths of the straps are retained, users needn't readjust the straps, so the detachable disposable mask is convenient for use.

4. Manufacturers can provide various forms of straps to meet users' fondness and requirements.

What are disclosed above are only the specification and the drawings of the preferred embodiments of the present invention and it is therefore not intended that the present invention be limited to these particular embodiments disclosed. It shall be understood by those skilled in the art that various equivalent changes may be made depending on the specification and the drawings of the present invention without departing from the scope of the present invention.

What is claimed is:

1. A detachable disposable mask, comprising:
a disposable mask body, having a thermo-plastic filter sheet which contains polyolefin material and four assembling portions respectively located on two ends of two opposite sides of the disposable mask body, each assembling portion having a perforation; and
two straps, each having two assembling members respectively located on two ends thereof, wherein the assembling members are respectively assembled on the perforations of the assembling portions of the disposable mask body.

2. The detachable disposable mask as claimed in claim 1, wherein the rim of the perforation of each assembling portion melts to form an enhancing ring.

3. The detachable disposable mask as claimed in claim 1, wherein each assembling portion further has a thermo-plastic enhancing board.

4. The detachable disposable mask as claimed in claim 1, wherein each strap has a strap body, each assembling member is a hook wedge and includes a fixing portion and a hook joint portion, and the fixing portions of the assembling members of each strap are respectively fixed on the two ends of each strap body, and the hook joint portions of the assembling members of each strap extend along the strap body of each strap and respectively detachably engage with the perforations of the assembling portions.

5. The detachable disposable mask as claimed in claim 1, wherein each strap has a strap body, each assembling member is an elastic protruding block, and the assembling members of each strap are respectively formed on the two ends of each strap body and the assembling members respectively detachably engage with the perforations of the assembling portions.

6. The detachable disposable mask as claimed in claim 1, wherein the assembling members of each strap are respectively detachably assembled on the assembling portions located on one corresponding side of the disposable mask body.

7. The detachable disposable mask as claimed in claim 1, wherein the assembling members of each strap are respectively detachably assembled on the corresponding assembling portions located on the two opposite sides of the disposable mask body.

8. A disposable mask body of a detachable disposable mask, comprising:
a thermo-plastic filter sheet which contains polyolefin material; and
four assembling portions respectively located on two ends of two opposite sides of the disposable mask body, each assembling portion having a perforation.

9. The disposable mask body of a detachable disposable mask as claimed in claim 8, wherein the rim of the perforation of each assembling portion melts to form an enhancing ring.

10. The disposable mask body of a detachable disposable mask as claimed in claim 8, wherein each assembling portion further has a thermo-plastic enhancing board.
